(19) United States
(12) Patent Application Publication
(10) Pub. No.: US 2022/0003329 A1
(43) Pub. Date: Jan. 6, 2022

(54) CHECK VALVE ARRANGEMENT AND MOTOR VEHICLE VACUUM PUMP

(71) Applicant: PIERBURG PUMP TECHNOLOGY GMBH, Neuss (DE)

(72) Inventors: Steffen SCHNURR, Essen (DE); Nabil Salim AL-HASAN, Korschenbroich (DE); Stanislaus RUSS, Moenchengladbach (DE); Tobias GRUENE, Arnsberg (DE); Petra HAGEN, Duisburg (DE); Marcel PIOTROWSKI, Korschenbroich (DE); Sebastian IRMER, Essen (DE)

(73) Assignee: Pierburg Pump Technology GmbH, Neuss (DE)

(21) Appl. No.: 17/295,445

(22) PCT Filed: Nov. 22, 2018
(86) PCT No.: PCT/EP2018/082254

§ 371 Date: May 20, 2021

(51) Int. Cl. F16K 15/02; F04C 25/02; F04C 29/12; F16K 27/02

(52) U.S. Cl. CPC F16K 15/028; F16K 27/0209; F04C 29/126; F04C 25/02

(57) ABSTRACT

A check valve arrangement includes a valve housing which radially defines a valve body chamber, a valve inlet opening arranged in the valve housing, a valve seat arranged at a first axial end of the valve body chamber to radially surround the valve inlet opening, a valve travel limiter arranged at a second axial end of the valve body chamber which is remote from the first axial end and the valve seat, and a disc-shaped valve body which is arranged loosely within the valve body chamber. The valve travel limiter includes a support ring which is fixed to the valve housing, a central transversal platform structure which axially protrudes from a side of the support ring which faces the valve seat, and a platform frame which axially connects the central transversal platform structure with the support ring. The platform frame includes at least one radial frame opening.

### CROSS REFERENCE TO PRIOR APPLICATIONS

This application is a U.S. National Phase application under 35 U.S.C. § 371 of International Application No. PCT/EP2018/082254, filed on Nov. 22, 2018. The International Application was published in English on May 28, 2020 as WO 2020/104034 A1 under PCT Article 21(2).

### FIELD

The present invention is directed to a check valve arrangement, in particular to a check valve arrangement which is provided with a disc-shaped valve body. The present invention is also directed to a motor vehicle vacuum pump which is provided with the check valve arrangement.

### BACKGROUND

WO 2017/036548 A1 describes a motor vehicle vacuum pump which is provided with a check valve arrangement which is arranged within the suction port of the vacuum pump. The check valve arrangement is provided with a valve housing which radially defines a valve body chamber. The check valve arrangement comprises a ring-shaped valve seat which is located at a first axial end of the valve body chamber and which radially surrounds a valve inlet opening. The check valve arrangement also comprises a ring-shaped valve travel limiter which is located at a valve-seat-remote second axial end of the valve body chamber. The check valve arrangement also comprises a disc-shaped valve body which is arranged within the valve body chamber. The valve body is axially preloaded by a preload spring towards the valve seat into a closed position. The fluid pressure within the check valve arrangement pushes the valve body against the preload spring towards the valve travel limiter into an open valve position if the check valve arrangement is loaded in a forward flow direction. A relatively high open force is, however, required to move the valve body against the preload spring into the open position. This reduces the pump performance of the vacuum pump.

EP 1 927 786 B1 and DE 10 2012 200 492 A1 both describe a check valve arrangement which is provided with a loosely arranged valve body. The fluid pressure within the check valve arrangement pushes the valve body towards the valve travel limiter into the open valve position if the check valve arrangement is loaded in a forward flow direction, and pushes the valve body towards the valve seat into the closed valve position if the check valve arrangement is loaded inversely. The loosely-arranged valve body can, however, tilt within the valve body chamber and can as a result become canted or jammed within the valve travel limiter. This prevents a reliable closing of the check valve arrangement if the flow direction inverses. The check valve arrangements described in EP 1 927 786 B1 and DE 10 2012 200 492 A1 also only provide a relatively low effective flow cross section so that the check valve arrangement only provides a relatively low fluid throughput in the open position.

### SUMMARY

An aspect of the present invention is to provide a check valve arrangement which requires only a relatively low open force, which provides a relatively high fluid throughput in the forward flow direction, and which reliably stops a fluid flow in the inverse flow direction.

In an embodiment, the present invention provides a check valve arrangement which includes a valve housing which radially defines a valve body chamber, a valve inlet opening arranged in the valve housing, a valve seat arranged at a first axial end of the valve body chamber to radially surround the valve inlet opening, a valve travel limiter arranged at a second axial end of the valve body chamber, the second axial end being remote from each of the first axial end and the valve seat, and a disc-shaped valve body which is arranged loosely within the valve body chamber. The valve travel limiter comprises a support ring which is fixed to the valve housing, a central transversal platform structure which is arranged to axially protrude from a side of the support ring which faces the valve seat, and a platform frame which is configured to axially connect the central transversal platform structure with the support ring. The platform frame comprises at least one radial frame opening.

### BRIEF DESCRIPTION OF THE DRAWINGS

The present invention is described in greater detail below on the basis of embodiments and of the drawings in which:

FIG. 1 shows a longitudinal section of a check valve arrangement according to the present invention in an open valve position;

FIG. 2 shows the check valve arrangement of FIG. 1 in a closed valve position;

FIG. 3 shows a perspective representation of a valve travel limiter of the check valve arrangement of FIG. 1; and

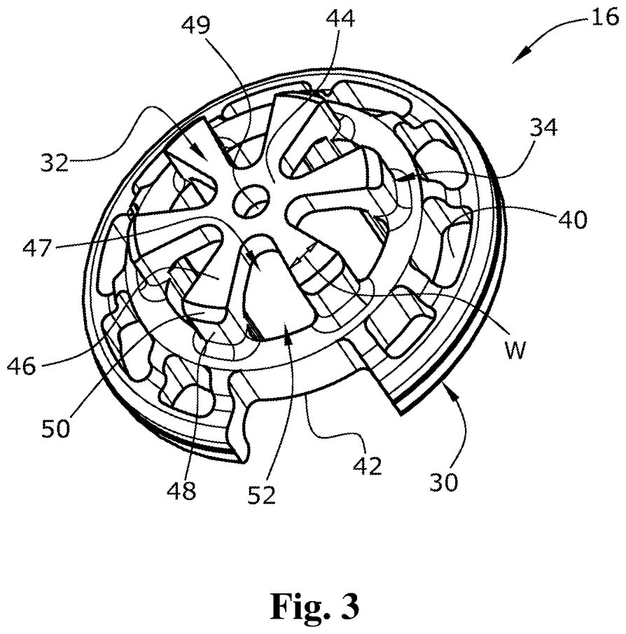

FIG. 4 shows a simplified representation of a motor vehicle vacuum pump according to the present invention, wherein the check valve arrangement of FIG. 1 is provided at a suction port of the vacuum pump.

### DETAILED DESCRIPTION

The check valve arrangement according to the present invention is provided with a valve housing which radially defines a valve body chamber. The valve housing can, for example, be provided to define a substantially cylindrical valve body chamber.

The check valve arrangement according to the present invention is also provided with a valve seat which is located at a first axial end of the valve chamber and which radially surrounds a valve inlet opening. The valve seat can be provided integrally with the valve housing, but can alternatively be provided as a separate element which is fixed at the valve housing. The valve seat can, for example, be provided at or close to an axial end of the valve housing.

The check valve arrangement according to the present invention is also provided with a valve travel limiter which is located axially spaced from the valve seat at a valve-seat-remote second axial end of the valve body chamber. The valve travel limiter is located downstream of the valve seat in view of a desired forward flow direction of the check valve arrangement. The valve travel limiter can be provided integrally with the valve housing, but can alternatively be provided as a separate element which is fixed at the valve housing, for example, via a press-fitting.

The check valve arrangement according to the present invention is also provided with disc-shaped valve body which is loosely arranged within valve body chamber, i.e., the valve body is able to move in an uninhibited manner within the extent of valve body chamber. The valve body is in particular not preloaded in any way by any kind of spring element etc.

The valve body can, for example, be provided with a circular transversal geometry, however, the valve body can alternatively be provided with any other transversal geometry. The valve body geometry in any case corresponds with the valve seat geometry so that the valve body is able to fluid-tightly close the opening which is defined by the valve seat. The valve body can, for example, be provided with a sealing lip element.

The valve body is typically provided with a diameter which is significantly smaller compared to the inside diameter of the valve body chamber so that the fluid can axially flow around and pass the valve body efficiently in an open valve position of the check valve arrangement. The peripheral region of the valve body can also be provided with recesses or openings to minimize the cross-section area of the valve body. The cross-section area of the valve body must, however, be large enough to provide a reliable total fluidic closing of the valve seat opening.

The valve body is axially moved between the open valve position and a closed valve position only by fluid pressure. If the valve arrangement is loaded in the forward flow direction, the valve body is moved into the open valve position in which the valve body is axially pressed against the valve travel limiter. If the valve arrangement is loaded in the forward flow direction, the valve body is moved into the closed valve position in which the valve body is axially pressed against the valve seat. The valve body is, however, only pressed against the valve seat as long as the valve arrangement is loaded in the inverse flow direction. As a result, if the valve arrangement is loaded in the forward flow direction, almost no opening force is required to move the valve body away from the valve seat into the open position.

According to the present invention, the valve travel limiter is provided with a support ring which is directly fixed to the valve housing. The support ring can, for example, be press-fitted in the valve housing. The support ring provides a reliable fixation of the valve travel limiter at the valve housing.

The valve travel limiter is also provided with a central transversal platform structure which axially protrudes from a valve-seat-facing side of the support ring. The platform structure provides a defined contact area for the valve body in the open valve position. The platform structure is in particular designed so that a canting or jamming of the valve body within the valve travel limiter is reliably avoided. The diameter of the platform structure can, for example, be smaller compared to the diameter of the valve body and/or the platform structure can, for example, be provided with axial incident flow openings. This provides a defined incident flow at the limiter-facing valve body backside in case of an inverse fluid flow direction. As a result, the valve travel limiter according to the present invention provides a closing of the valve seat opening if the fluid flow direction within the check valve arrangement inverses so that a fluid flow in the inverse flow direction is immediately and reliably stopped.

The valve travel limiter is also provided with a platform frame which axially connects the central transversal platform structure with the support ring to reliably fix the platform structure at the support ring and, as a result, at the valve housing. According to the present invention, the platform frame is provided with at least one radial frame opening which allows a radial fluid flow through the valve travel limiter. The flow cross section of the frame opening can be increased in a simple way by increasing the axial height of the platform frame. As a result, the valve travel limiter can be designed so that the effective flow cross section of the valve arrangement is not limited by the valve travel limiter, but only by the valve body geometry. The check valve arrangement according to the present invention therefore allows a relatively high fluid throughput in the forward flow direction.

In an embodiment of the present invention, the platform frame can, for example, be composed of several axially extending platform pillars which circumferentially define several radial frame openings therebetween. The platform pillars can, for example, be equidistantly distributed along the circumference of the platform structure and can, for example, be provided with a relatively small circumferential width. The platform pillars provide a mechanically robust support of the platform structure at the support ring. However, the platform pillars only cover a relatively small circumferential area so that the frame openings have a relatively large cross section and, as a result, allow a high fluid throughput.

The platform structure can, for example, be substantially star-shaped with several platform arms extending radially outwardly from a central hub element. The platform arms can, for example, be distributed equidistantly along the circumference of the platform structure. The platform arms circumferentially define several axial incident flow openings. The platform arms and the central hub element reliably avoid a jamming or canting of the valve body within the valve travel limiter. The incident flow openings between the platform arms provide a defined axial incident flow at the valve body if the flow direction within the check valve arrangement inverses. As a result, this platform structure design provides a reliable valve body movement into the closed valve position and, as a result, provides an immediate and reliable interruption of an inverse fluid flow.

Each radial platform arm can, for example, be fixed to the support ring by a corresponding axial platform pillar. The platform arms and the platform pillars can, for example, be provided with the same axial width. This provides a mechanically robust valve travel limiter which allows a high fluid throughput in the forward flow direction and also provides a reliable valve body movement towards the closed valve position if the fluid flow direction is inversed.

In an embodiment of the present invention, the circumferential width of the platform arms can, for example, increase from the central hub element towards the radial outside. This reliably avoids a canting or jamming of the valve body within the platform structure and also allows a relatively homogeneous incident flow at the valve body backside through the platform structure. This provides a reliable valve body movement towards the closed valve position if the fluid flow direction is inversed.

The support ring can, for example, be provided with several axial support ring openings which are arranged along the circumference of the support ring. The support ring openings can, for example, be distributed equidistantly along the circumference. The support ring openings increase the effective flow cross section of the valve travel limiter and, as a result, increases the fluid throughput of the check valve arrangement in the forward flow direction.

The check valve arrangement according to the present invention can be provided within a motor vehicle vacuum pump, wherein the check valve arrangement is provided at a suction port of the vacuum pump. The vacuum pump is utilized to provide a vacuum to a motor vehicle pneumatic system, for example, to a pneumatic vehicle brake system. The check valve arrangement according to the present invention allows a fast and efficient depressurizing of the pneumatic system by the vacuum pump and reliably avoids a vacuum breach via the pump if the pump stops and is inactive.

An embodiment of the present invention is described below under reference to the enclosed drawings.

The described check valve arrangement 10 comprises a pot-shaped valve housing 12 with an integral valve seat 14, a valve travel limiter 16 which is fixed within the valve housing 12, and a disc-shaped valve body 18 which is loosely arranged within the valve housing 12.

The valve housing 12 comprises a cylindrical housing sidewall 20 and a transversal housing base 22. The housing sidewall 20 radially defines a valve body chamber 24, and the housing base 22 defines the valve body chamber 24 in a first axial direction. The housing base 22 is provided with a valve inlet opening 26 and defines the valve seat 14 which radially surrounds the valve inlet opening 26. The valve seat 14 is as a result located at a first axial end 28 of the valve body chamber 24.

The valve travel limiter 16 comprises a support ring 30, a platform structure 32 which axially protrudes from a valve-seat-facing axial side of the support ring 30, and a platform frame 34 which axially connects the platform structure 32 with the support ring 30. The valve travel limiter 16 is located at a valve-seat-remote second axial end 36 of the valve body chamber 24. The valve travel limiter 16 is press-fitted into the valve housing 12 so that the support ring 30 of the valve travel limiter 16 engages into a circumferential support groove 38 which is provided at the radial inside of housing sidewall 20.

The support ring 30 is provided with several axial support ring openings 40 which are distributed along the circumference of the support ring 30. The radial outside of the support ring 30 is provided with a mounting recess 42 which simplifies the press-fitting of the valve travel limiter 16 into the valve housing 12.

The platform structure 32 is provided to be substantially star-shaped with a central hub element 44 and several platform arms 46 which extend radially outwardly from the hub element 44. The platform arms 46 are provided so that their circumferential width W continuously increases from the hub element 44 towards the radial outside. The platform arms circumferentially define several axial incident flow openings 47 which allow an axial fluid flow through the platform structure 32. The hub element 44 is provided with an additional axial incident flow opening 49 which is located at the center of the hub element 44.

The platform frame 34 is composed of several axially extending platform pillars 48, wherein each platform pillar 48 axially connects a platform arm end 50 with the support ring 30. The platform pillars 48 circumferentially define several radial frame openings 52 therebetween, which allow a radial fluid flow through the platform frame 34. The radial frame openings 52 of the platform frame 34 and the axial incident flow opening 47 of the platform structure 32 seamlessly merge into each other.

The valve body 18 is loosely arranged within the valve body chamber 24 which is axially defined by the valve seat 14 at the first axial end 28 and by the valve travel limiter 16 at the opposite second axial end 36. The valve body 18 is provided with a ring-shaped sealing lip element 54 which is located at the valve-seat-facing axial side of the valve body 18.

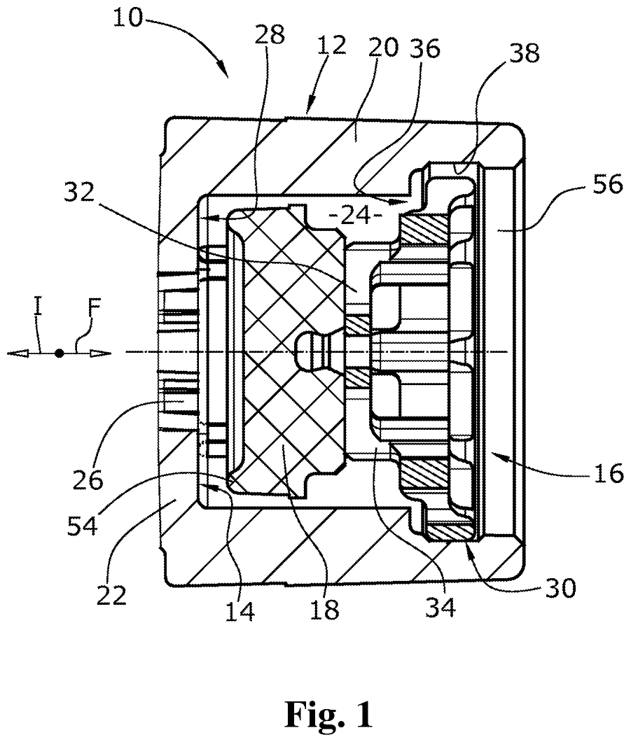

The valve body 18 is able to move in an uninhibited manner within the extent of valve body chamber 24. If the check valve arrangement 10 is provided with a fluid flow in a forward flow direction F, the fluid pressure pushes the valve body 18 against the valve travel limiter 16 into an open valve position as shown in FIG. 1. In the open valve position, the valve body 18 is in contact with the valve travel limiter 16 so that the valve body 18 does not cover the valve inlet opening 26. Fluid can as a result flow via the valve inlet opening 26 into the valve body chamber 24. The fluid can flow axially around the radial outside of the valve body 18 towards the valve travel limiter 16 and can flow through the valve travel limiter 16 via the radial frame openings 52 as well as via the axial support ring opening 40 towards a valve outlet opening 56. The radial frame openings 52 and the axial support ring opening 40 provide a relatively large effective flow cross section so that the check valve arrangement 10 according to the present invention allows a relatively high fluid throughput in the forward flow direction F.

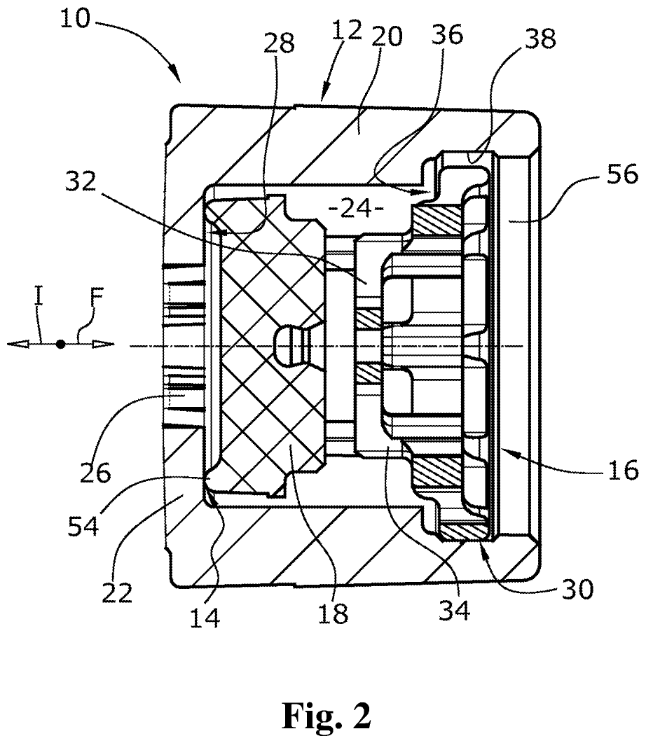

If the check valve arrangement 10 is provided with a fluid flow in an inverse flow direction I, the fluid pressure pushes the valve body 18 against the valve seat 14 into a closed valve position as shown in FIG. 2. In the closed valve position, the valve body is pressed against the valve seat 14 so that the sealing lip element 54 fluid-tightly closes the opening which is defined by the valve seat 14 and, as a result, avoids a fluid flow from the valve body chamber 24 towards the valve inlet opening 26. Since the valve body 18 cannot become canted or jammed within the valve travel limiter 16, the check valve arrangement 10 according to the present invention reliably interrupts a fluid flow in the inverse flow direction I.

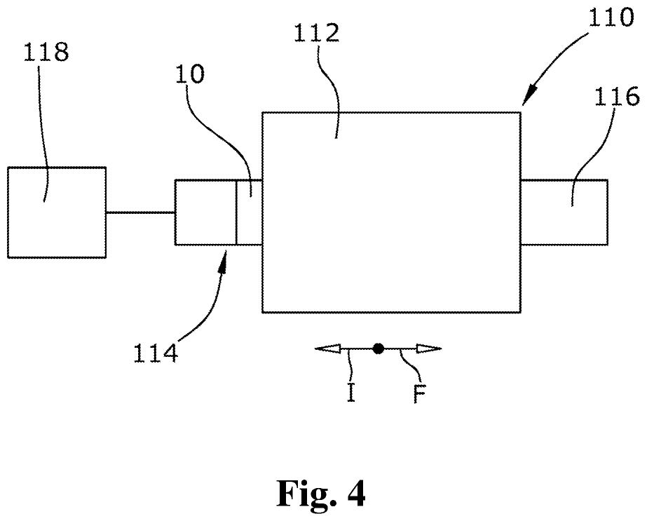

FIG. 4 shows a motor vehicle vacuum pump 110 comprising a pump unit 112 with a suction port 114 and a pressure port 116. The pump unit 112 can, for example, be an electrically or mechanically driven rotary vane pump. In the shown embodiment of the present invention, the suction port 114 is fluidically connected to a motor vehicle brake system 118 to provide a vacuum for actuating the motor vehicle brake system 118.

The motor vehicle vacuum pump 110 is provided with the check valve arrangement 10 which is described above. The check valve arrangement 10 is provided within the suction port 114, wherein the check valve arrangement 10 is arranged so that the forward flow direction F points towards the pump unit 112 and the inverse flow direction I points towards the motor vehicle brake system 118. The check valve arrangement 10 thereby allows a fluid flow from the motor vehicle brake system 118 into the pump unit 112, but blocks an inverse fluid flow from the pump unit 112 into the motor vehicle brake system 118. The check valve arrangement 10 therefore avoids a vacuum breach within the motor vehicle brake system 118 in case of a stopped and inactive motor vehicle vacuum pump 110.

The present invention is not limited to embodiments described herein; reference should be had to the appended claims.

### LIST OF REFERENCE NUMERALS

10 check valve arrangement
12 valve housing
14 valve seat
16 valve travel limiter
18 valve body
20 housing sidewall
22 housing base
24 valve body chamber
26 valve inlet opening
28 first axial end
30 support ring
32 platform structure
34 platform frame
36 second axial end
38 support groove
40 axial support ring openings
42 mounting recess
44 hub element
46 platform arms
47 axial incident flow openings
48 platform pillars
49 incident flow opening
50 platform arm ends
52 radial frame openings
54 sealing lip element
56 valve outlet opening
110 motor vehicle vacuum pump
112 pump unit
114 suction port
116 pressure port
118 motor vehicle brake system
F forward flow direction
I inverse flow direction
W circumferential width (of the platform arm)

What is claimed is:

1-7. (canceled)

8: A check valve arrangement comprising:
a valve housing which radially defines a valve body chamber;
a valve inlet opening arranged in the valve housing;
a valve seat arranged at a first axial end of the valve body chamber to radially surround the valve inlet opening;
a valve travel limiter arranged at a second axial end of the valve body chamber, the second axial end being remote from each of the first axial end and the valve seat, the valve travel limiter comprising,
a support ring which is fixed to the valve housing,
a central transversal platform structure which is arranged to axially protrude from a side of the support ring which faces the valve seat, and
a platform frame which is configured to axially connect the central transversal platform structure with the support ring, the platform frame comprising at least one radial frame opening; and
a disc-shaped valve body which is arranged loosely within the valve body chamber.

9: The check valve arrangement as recited in claim 8, wherein the platform frame further comprises a plurality of axially extending platform pillars which circumferentially define a plurality of radial frame openings.

10: The check valve arrangement as recited in claim 8, wherein the central transversal platform structure is shaped substantially as a star so that the central transversal platform structure comprises a plurality of platform arms which are arranged to extend radially outwards from a central hub element.

11: The check valve arrangement as recited in claim 10, wherein,
the central transversal platform structure further comprises a plurality of axial platform pillars, and
each of the plurality of platform arms is fixed to the support ring via a corresponding one of the plurality of axial platform pillars.

12: The check valve arrangement as recited in claim 11, wherein,
a circumferential width of the plurality of platform arms increases from the central hub element towards a radial outside.

13: The check valve arrangement as recited in claim 8, wherein the support ring comprises a plurality of axial support ring openings which are arranged along a circumference of the support ring.

14: A motor vehicle vacuum pump comprising:
a suction port; and
the check valve arrangement as recited in claim 8,
wherein,
the check valve arrangement is arranged at the suction port of the motor vehicle vacuum pump.
